(19) United States
(12) Patent Application Publication
(10) Pub. No.: US 2018/0291153 A1
(43) Pub. Date: Oct. 11, 2018

(54) ISOCYANATE-FREE REACTIVE POLYURETHANE COMPOSITIONS

(71) Applicant: Evonik Degussa GmbH, Essen (DE)

(72) Inventors: Christina Cron, Velbert (DE); Gabriele Brenner, Dülmen (DE); Benjamin Schaeffner, Dorsten (DE); Angela Köckritz, Berlin (DE); Jens Deutsch, Rangsdorf (DE); Katja Neubauer, Rostock (DE)

(21) Appl. No.: 15/578,013

(22) PCT Filed: Jun. 13, 2016
(86) PCT No.: PCT/EP2016/063435

§ 371 Date: Nov. 29, 2017

(30) Foreign Application Priority Data
Jun. 30, 2015 (EP) 15174540.3

(51) Int. Cl. C08G 71/04; C09J 175/06

(52) U.S. Cl. CPC C08G 71/04; C08G 2170/20; C09J 175/06

(57) ABSTRACT

The present invention relates to isocyanate-free polyurethane composition for adhesives, sealants and coating materials. In particular, the present invention relates to isocyanate-free polyurethane composition including polymers (A) carrying cyclic carbonate groups, which do not comprise or are not based on isocyanates, obtained by reaction of polymers which carry carboxyl groups, selected from the group encompassing polyesters based on diols or polyols and on dicarboxylic or polycarboxylic acids and/or derivatives thereof, or poly(meth)acrylates, with five-membered cyclic carbonates that are functionalized with hydroxyl groups, and a curing agent (B) having at least one amino group and at least one further functional group, wherein the further functional group is not an isocyanate group.

The present invention relates to isocyanate-free polyurethane compositions for adhesives, sealants and coating materials.

Polyurethane adhesives represent an important class of adhesive for many applications, for example in car making, furniture manufacture or textile bonding. Hotmelt adhesives represent one particular form. They are solid at room temperature and are melted by heating, and are applied to the substrate in substance at elevated temperature. On cooling, they solidify again and thus provide, even after just a short time, a solid adhesive bond with high handling strength. The handling of volatile solvents and also the drying step for evaporating off the solvent are done away with. Since in general no volatile organic compounds (VOCs) are used or are formed on curing, hotmelt adhesives in many cases also meet requirements for low emission levels.

A subgroup of the hotmelt adhesives is that of reactive hotmelt adhesives which, after application, additionally crosslink and thus cure irreversibly to form a thermoset. As compared with the non-crosslinking, purely physically curing thermoplastic hotmelt adhesives, the additional chemical curing leads to a higher stability of the adhesive bond.

The adhesive may be applied as either a one-part or two-part system. In the case of two-part systems, the two individual reactive components are not melted and mixed with one another until immediately prior to adhesive application. In the case of one-part systems, the two individual reactive components are mixed and/or reacted first, with the ratios of the reaction components being selected such that there is no crosslinking. Curingis controlled by external influencing factors. Examples of known systems include hot-curing, radiation-curing and moisture-curing systems.

One example of reactive polyurethane hotmelt adhesives are one-part moisture-curing hotmelt adhesives. For these adhesives, functional groups are introduced into the binder that react with one another in the presence of water, e.g. atmospheric humidity. These may be, for example, isocyanate groups. In the case of crosslinking, they form urethane groups, which on account of their capacity for hydrogen bonds ensure effective substrate adhesion and high strength of the adhesive.

The one-part moisture-curing polyurethane hotmelt adhesives are generally isocyanate-functionalized polymers, which are accessible by reaction of polyols or polyol mixtures with an excess of polyisocyanates. Also conceivable, however, are two-part adhesive applications, in which the polyols and the polyisocyanates are present as individual components and are mixed immediately prior to adhesive application.

While the reactive polyurethane hotmelt adhesives based on isocyanates that have been described to date in the prior art do exhibit entirely good adhesive properties on a large number of substrates, they are not without their disadvantages. Firstly, isocyanates, especially those of low molecular mass and not polymer-bonded, are toxicologically objectionable. This means that in the course of production, there are complicated workplace safety measures to be taken, and that the product must be labelled accordingly. Furthermore, it is necessary to ensure that during adhesive application and in the end application, the release of isocyanates into the breathed-in air or by migration is prevented. A further disadvantage concerns the sensitivity of isocyanates to hydrolysis. Accordingly, all of the substances must be dried prior to production of the adhesive. The adhesive must be produced, stored and applied under inert conditions, to the exclusion of atmospheric humidity. If the humidity is too high, bubbles may be formed as a result of liberated CO₂, disrupting the adhesion and transparency of the adhesive bond.

Silane-modified hotmelt adhesives are prepared by reaction of isocyanate-containing prepolymers with aminoalkylsilanes or of hydroxyl-containing polymers with a reaction product of polyisocyanates and aminoalkylsilane or with isocyanatosilane.

Thermally crosslinkable polyurethane compositions of the prior art are mixtures of hydroxyl-terminated polymers and externally or internally blocked polyisocycanate crosslinkers which are solid at room temperature. The disadvantage of externally blocked systems lies in the elimination of the blocking agent during the thermal crosslinking reaction. Since the blocking agent may therefore be emitted to the environment, it is necessary on environmental and workplace safety grounds to take special precautions to clean the outgoing air and recover the blocking agent. Internally blocked systems require high curing temperatures generally of at least 180° C.

WO 2006/010408 describes two-component binders consisting of an isocyanate-containing compound A which carries at least two cyclic carbonate groups, and a compound B which carries at least two amino groups. US 2005/0215702 describes the use of urethane diols, obtainable by reaction of cyclic carbonates with amino alcohols, as additives in moisture-curing polyurethane adhesives.

Preferably solvent-containing formulates are disclosed. Solvent-based systems possess a number of disadvantages: In the course of handling, it is necessary to take account of the volatility and the resultant emissions, which may have health implications. Moreover, the solvent must be removed by evaporation, in an additional drying step. This is a general disadvantage relative to hotmelt adhesives, where there is no need for a drying step to evaporate off solvents. Hence hotmelt adhesives generally meet the requirements of low emission levels. On cooling, they solidify again and thus provide, even after just a short time, a solid adhesive bond with high handling strength.

In accordance with the prior art, the polymer is equipped with at least two cyclic carbonate groups generally by subsequent functionalisation of a polymer which has already been prepared. Customary in this context is the addition reaction of cyclic hydroxyalkyl carbonates onto polymers which carry anhydride groups or isocyanate groups. These processes lead to secondary reactions and to a broad molar weight distribution, with adverse consequences for the viscosity.

It is an object of the present invention, therefore, to provide reactive polyurethane compositions having good adhesion properties and bond strengths, these compositions preferably being applied from the melt and being devoid of isocyanate components.

This object is achieved in accordance with the invention by polyurethane compositions based on isocyanate-free polymers.

A first subject of the present invention, accordingly, are isocyanate-free polyurethane compositions comprising polymers (A), which carry cyclic carbonate groups and which do not contain or are not based on any isocyanates, obtained by reaction of polymers which carry carboxyl groups, selected from the group encompassing polyesters based on diols or polyols and on dicarboxylic or polycarboxylic acids and/or derivatives thereof, or poly(meth)acrylates, with five-membered cyclic carbonates that are functionalized with hydroxyl groups, and a curing agent (B) having at least one amino group and at least one further functional group, with the proviso that the further functional group is not an isocyanate group. The isocyanate-free polyurethane compositions of the invention are preferably adhesives, more particularly hotmelt adhesives, a preference existing in turn for one-part thermally crosslinkable and two-part isocyanate-free polyurethane hotmelt adhesives.

The present invention accordingly describes isocyanate-free binders for adhesives, sealants and coating materials, especially those based on polyurethane. The polymeric binder is functionalized with the crosslinkable group not via isocyanate groups, but instead via cyclic carbonate groups. Accordingly, a polymer which carries at least one cyclic five-membered carbonate group is reacted with functionalized amines to give the curable polymer binder. The functionalized amine must carry at least one amino group, with primary amino groups being preferred.

An advantage of the polyurethane compositions of the invention is that they manage entirely without the use of isocyanates. At the curing stage, the urethane groups are formed not through the reaction of alcohols with isocyanates, but instead from cyclic carbonate groups with amines. As a result of the attack by the amino group on the carbonyl carbon, the carbonate ring is opened, and a hydroxyurethane group is formed. The reaction rate is dependent in particular on the reaction temperature and on the structure of the amine, and can be accelerated by means of catalysts. The adhesives of the invention are notable here for the fact that they cure by means of readily controllable external influencing factors such as, for example, atmospheric humidity, an increase in temperature, or radiation sources. Isocyanate-free reactive polyurethane compositions, more particularly hotmelt adhesives, which manage without isocyanates in the synthesis have not hitherto been described in the prior art. Furthermore, the polyurethane compositions of the invention are also not based on epoxide-containing systems or on precursors which often during their preparation, using epichlorohydrin, for example, give off unwanted by-products such as halogens, for example.

The polyurethane compositions of the invention are suitable both for use in one-part systems and in two-part systems.

In the case of one-part polyurethane compositions, more particularly adhesives, the preparation of the mixture is independent in time from the application of the adhesive, being situated in particular at a much earlier juncture. Following the application of the polyurethane adhesive of the invention, curing takes place as a result, for example, of thermally induced reaction between the reactants present in the adhesive.

In the case of the two-part adhesives, the mixture is produced directly prior to adhesive application. They are especially suitable for producing highly branched adhesives for structural bonds.

The polymers (A) with cyclic carbonate groups that are used in accordance with the invention comprise diol- or polyol-based polyesters and dicarboxylic or polycarboxylic acids and/or derivatives thereof or poly(meth)acrylates, which carry cyclic carbonate groups as end groups or in the side chain. They may also constitute mixtures of two or more different diol- or polyol-based polyesters and dicarboxylic or polycarboxylic acids and/or derivatives thereof and/or poly(meth)acrylates carrying carbonate groups, in any mixing proportion. The polymer carrying cyclic carbonate groups carries at least one and preferably two cyclic five-membered carbonate group(s).

Polymers of this kind are obtained, within the context of the present invention, by reaction of carboxyl-carrying diol- or polyol-based polyesters and dicarboxylic or polycarboxylic acids and/or derivatives thereof, or poly(meth)acrylates with hydroxyl-functionalized five-membered cyclic carbonates, preferably without the addition of isocyanates.

Corresponding poly(meth)acrylates, i.e. polyacrylates or polymethacrylates, can be synthesized, for example, by free or controlled radical polymerization of acrylates or methacrylates, where at least one of the comonomers mentioned has a carboxyl functionality. This may, for example, be acrylic acid or methacrylic acid.

More preferably the polymers which carry carboxyl groups are diol- or polyol-based polyesters and dicarboxylic or polycarboxylic acids and/or derivatives thereof, which in turn are synthesized preferably by melt condensation of diols or polyols and dicarboxylic or polycarboxylic acids and/or derivatives thereof.

With regard to the di- or polyols and di- or polycarboxylic acids, there are no restrictions in principle, and it is possible in principle for any mixing ratios to occur. The selection is guided by the desired physical properties of the polyester. At room temperature, these may be solid and amorphous, liquid and amorphous or/and (semi)crystalline.

Di- or polycarboxylic acids used may be any organic acids which are known to those skilled in the art and contain two or more carboxyl functionalities. In the context of the present invention, carboxyl functionalities are also understood to mean derivatives thereof, for example esters or anhydrides.

The di- or polycarboxylic acids may especially be aromatic or saturated or unsaturated aliphatic or saturated or unsaturated cycloaliphatic di- or polycarboxylic acids. Preference is given to using bifunctional dicarboxylic acids.

Examples of suitable aromatic di- or polycarboxylic acids and derivatives thereof are compounds such as dimethyl terephthalate, terephthalic acid, isophthalic acid, naphthalenedicarboxylic acid and phthalic anhydride.

Examples of linear aliphatic dicarboxylic or polycarboxylic acids include oxalic acid, dimethyl oxalate, malonic acid, dimethyl malonate, succinic acid, dimethyl succinate, glutaric acid, dimethyl glutarate, 3,3-dimethylglutaric acid, adipic acid, dimethyl adipate, pimelinic acid, sorbic acid, azelaic acid, dimethyl azelate, sebacic acid, dimethyl sebacate, undecanedicarboxylic acid, 1,10-decanedicarboxylic acid, 1,12-dodecanedicarboxylic acid, brassylic acid, 1,14-tetradecanedicarboxylic acid, 1,16-hexadecanedioic acid, 1,18-octadecanedioic acid, dimer fatty acids and mixtures thereof.

Examples of unsaturated linear di- and/or polycarboxylic acids include itaconic acid, fumaric acid, maleic acid or maleic anhydride.

Examples of saturated cycloaliphatic dicarboxylic and/or polycarboxylic acids include derivatives of 1,4-cyclohexanedicarboxylic acids, 1,3-cyclohexanedicarboxylic acids and 1,2-cyclohexanedicarboxylic acids.

It is possible in principle to use any desired diols or polyols for the preparation of the polyesters. Polyols are understood to mean compounds bearing preferably more than two hydroxyl groups. For instance, linear or branched aliphatic and/or cycloaliphatic and/or aromatic diols or polyols may be present.

Examples of suitable diols or polyols are ethylene glycol, propane-1,2-diol, propane-1,3-diol, butane-1,4-diol, butane-1,3-diol, butane-1,2-diol, butane-2,3-diol, pentane-1,5-diol, hexane-1,6-diol, octane-1,8-diol, nonane-1,9-diol, dodecane-1,12-diol, neopentyl glycol, butylethylpropane-1,3-diol, methylpropane-1,3-diol, methylpentanediols, cyclohexanedimethanols, tricyclo[2.2.1]decanedimethanol, isomers of limonenedimethanol and isosorbitol, trimethylolpropane, glycerol, 1,2,6-hexanetriol, pentaerythritol and mixtures thereof. Aromatic diols or polyols are understood to mean reaction products of aromatic polyhydroxyl compounds, for example hydroquinone, bisphenol A, bisphenol F, dihydroxynaphthalene etc., with epoxides, for example ethylene oxide and propylene oxide. Diols or polyols present may also be ether diols, i.e. oligomers or polymers based, for example, on ethylene glycol, propylene glycol or butane-1,4-diol.

Preference is given to using bifunctional diols and dicarboxylic acids.

Polyols or polycarboxylic acids having more than two functional groups may be used as well, such as trimellitic anhydride, trimethylolpropane, pentaerythritol or glycerol, for example. Moreover, lactones and hydroxycarboxylic acids may be used as constituents of the polyester.

The softening point of the carboxyl-carrying polymers used in the reaction with hydroxyl-functionalized five-membered cyclic carbonates is preferably at ≤170° C., more preferably ≤150° C. The polymers are stable at ≤200° C. for at least 24 hours under inert conditions, meaning that they do not exhibit any significant change in properties or increase in colour number.

It is essential that the carboxyl-bearing polymers used in the reaction with hydroxyl-functionalized five-membered cyclic carbonates carry a sufficient number of carboxyl groups. Thus, the concentration of acid end groups, determined to DIN EN ISO 2114, is especially between 1 and 200 mg KOH/g, but preferably 10 to 100 mg KOH/g and most preferably 20 to 60 mg KOH/g.

The hydroxyl end groups, determined by titrimetric means to DIN 53240-2, may be any desired concentration, generally between 0 and 200 mg KOH/g, preferably between 0 and 10 mg KOH/g.

In the simplest embodiment, the carboxyl-carrying polymers are reacted with hydroxyl-functionalized five-membered cyclic carbonates, preferably glycerol carbonate, preferably in the presence of a catalyst.

In a further and preferred embodiment, the preparation of the carboxyl-carrying polymers and the reaction with hydroxyl-functionalized five-membered cyclic carbonates, preferably glycerol carbonate, preferably in the presence of a catalyst, are combined with one another to give a two-stage process. Accordingly, in the preferred variants, in a first reaction step, the carboxyl-carrying polymers are prepared by polycondensation, or polymerization, and, in a second reaction step, the resulting carboxyl-carrying polymers are reacted with hydroxyl-functionalized five-membered cyclic carbonates, preferably glycerol carbonate, preferably in the presence of a catalyst.

The preparation of the carboxyl-bearing polymers, especially in the case of the polyesters used with preference, in the first reaction step is preferably effected via a melt condensation. For this purpose, the aforementioned di- or polycarboxylic acids and di- or polyols are used in a molar ratio of carboxyl to hydroxyl groups of 0.8 to 1.5:1, preferably 1.0 to 1.3:1. An excess of carboxyl groups over hydroxyl groups is preferable in order to obtain a sufficient concentration of carboxyl groups in the polyester.

The polycondensation takes place at temperatures between 150 and 280° C. within from 3 to 30 hours. First of all, a major part of the amount of water released is distilled off under atmospheric pressure. In the further course, the remaining water of reaction, and also volatile diols, are eliminated, until the target molecular weight is achieved. Optionally this may be made easier through reduced pressure, through an enlargement in the surface area, or by the passing of an inert gas stream through the reaction mixture. The reaction may additionally be accelerated by addition of an azeotrope former and/or of a catalyst before or during the reaction. Examples of suitable azeotrope formers are toluene and xylenes. Typical catalysts are organotitanium compounds such as tetrabutyl titanate. Also conceivable are catalysts based on other metals, such as tin, zinc or antimony, for example. Also possible are further additives and process aids such as antioxidants or colour stabilizers.

In the second reaction step of the preferred embodiment, the resulting carboxyl-carrying polymers are reacted with hydroxyl-functionalized five-membered cyclic carbonates, preferably glycerol carbonate, preferably in the presence of a catalyst.

Examples of suitable hydroxyl-functionalized five-membered cyclic carbonates are 4-hydroxymethyl-1,3-dioxolan-2-one, 4-hydroxyethyl-1,3-dioxolan-2-one, 4-hydroxypropyl-1,3-dioxolan-2-one or sugar derivatives such as methyl-3,4-O-carbonyl-β-D-galactopyranoside, and 4-hydroxymethyl-1,3-dioxolan-2-one (glycerol carbonate) is especially preferred. Glycerol carbonate is commercially available and is obtained from glycerol wastes in biodiesel production.

The reaction with glycerol carbonate is effected at elevated temperatures, but below the breakdown temperature of the glycerol carbonate. At temperatures above 200° C., a rise in the hydroxyl group concentration is observed, probably as a result of partial ring opening of the glycerol carbonate with subsequent decarboxylation. This side reaction can be monitored via a rise in the hydroxyl number, determined by titrimetric means to DIN 53240-2. The rise in the hydroxyl number should be 0 to a maximum of 100 mg KOH/g, preferably 0 to a maximum of 50 mg KOH/g, more preferably 0 to a maximum of 20 mg KOH/g, and most preferably 0 to a maximum of 10 mg KOH/g.

Preferably, therefore, the reaction takes place at 100-200° C., more preferably at 140 to 200° C. and very preferably at temperatures around 180° C. At this temperature, the polymer carrying carboxyl groups is in the form of a liquid or of a viscous melt. The synthesis takes place preferably in bulk without addition of solvent. Thus, the entire process according to the invention is preferably effected without the addition of solvent in the liquid phase or melt.

The carboxyl-bearing polymer is initially charged in a suitable reaction vessel, for example a stirred tank, and heated to the reaction temperature, and the hydroxyl-functionalized five-membered cyclic carbonate, preferably glycerol carbonate, and in the preferred embodiment the catalyst, are added. The water that forms during the reaction is removed continuously by means of a distillation apparatus. In order to facilitate the removal of water and to shift the equilibrium of the esterification reaction to the side of the modified product, the internal vessel pressure during the reaction is lowered stepwise from standard pressure to <100 mbar, preferably <50 mbar and more preferably <20 mbar. The course of the reaction is monitored via the concentration of free carboxyl groups, measured via the acid number. The reaction time is 2 to 20 hours. In general, no further purification of the polymer is required.

The amount of glycerol carbonate is guided by the concentration of carboxyl groups in the polymer. Preference is given to working under stoichiometric conditions or with a slight excess of glycerol carbonate. A relatively small excess of glycerol carbonate leads to much longer reaction times compared to higher excesses. However, if the excess of glycerol carbonate chosen is too high, unconverted glycerol carbonate remains in the product and can be separated from the reaction mixture only with great difficulty because of the high boiling point of glycerol carbonate. The glycerol carbonate excess is 0-50 mol %, preferably 0-10 mol % and most preferably 10 mol %, based on the molar amount of free carboxyl groups in the carboxyl-bearing polymer.

Under the reaction conditions described, the addition of a catalyst is preferable in order to achieve a sufficient reaction rate. In the absence of a catalyst, in general, no significant reduction in the carboxyl group concentration and only a slow chemical reaction are observed. Suitable catalysts are in principle substances which act as Lewis acids. Lewis bases, for example tertiary amines, do not show any catalytic reactivity.

However, titanium-containing Lewis acids which are frequently also used in melt condensations at high temperatures have a tendency to unwanted side reactions. It has been found that the addition of titanium salts and titanium organyls as catalysts leads to a distinct orange-brown colour. Moreover, the catalytic activity is comparatively low. In contrast, titanium-free Lewis acids show a distinct acceleration of the reaction and at the same time have a tendency to only slight discolouration. Transparent to yellowish melts are obtained. The titanium-free Lewis acids used with preference include both nonmetallic Lewis acids, for example p-toluenesulphonic acid or methylsulphonic acid, but also titanium-free metallic Lewis acids, for example zinc salts. Particular preference is given to using tin-containing Lewis acid catalysts; suitable tin compounds are, for example, tin(II) octoate or, more preferably, monobutylstannic acid. The amount of catalyst is preferably 1-10 000 ppm, more preferably 100-1000 ppm, based on the overall reaction mixture. It is also possible to use mixtures of different catalysts. In addition, it is possible to add the amount of catalyst in several individual portions.

In the course of performance of the second reaction step, it is possible to add further additives and colour assistants such as antioxidants or colour stabilizers. Corresponding components are known to those skilled in the art.

As a result of the process described above, polymers are obtained which contain five-membered cyclic carbonate groups and can be used well for the purposes of the present invention. With more particular preference, the polymers are polyesters containing cyclic carbonate groups.

The carbonate-functionalized polymers used possess an acid number, determined to DIN EN ISO 2114, of ≤10 mg KOH/g, preferably ≤5 mg KOH/g and more preferably ≤2 mg KOH/g. The concentration of hydroxyl end groups, determined titrimetrically to DIN 53240-2, is between 0 and 100 mg KOH/g, preferably between 0 and 20 mg KOH/g. The functionality in terms of cyclic five-membered carbonate groups is at least one. The concentration of polymer-bonded cyclic carbonate groups, determined for example via NMR spectroscopy, is 0.1 mmol/g to 5 mmol/g, preferably 0.3 mmol/g to 1 mmol/g.

The polymeric binders carrying carbonate groups may be solid or liquid at room temperature. The softening point of the polymer is −100° C. to +200° C., preferably between −80° C. and +150° C.

The softening point may either be a glass transition temperature or else a melting point. The thermal properties are determined by the DSC method to DIN 53765.

Likewise a constituent of the polyurethane compositions of the invention are the curing agents (B) having at least one amino group and at least one further functional group, with the proviso that the further functional group is not an isocyanate group. The curing agent comprises low molecular mass or polymeric substances which carry at least one amino group, preferably a primary amino group. In addition to the amino functionality, curing agent (B) has at least one further functional group, with the proviso that the further functional group is not an isocyanate group. The functional group serves in particular for crosslinking in the reactive adhesive, sealant or coating material. However, it must not be an isocyanate group. For the purposes of the present invention, a plurality of functional groups, and different functional groups, are conceivable in compound (B). The further functional group preferably comprises amino, silyl, vinyl or thiol groups.

In a further embodiment of the present invention, the functional group of curing agent (B) is a silyl group, preferably an alkoxysilyl group. In this way, binders are obtained which can be used in particular as one-part moisture-curing hotmelt adhesives, since the silyl groups are able to form a silane network on curing. In the case of this embodiment, aminoalkylsilanes are used with preference as compound (B). They include, for example, 3-aminopropylmethyldiethoxysilane, 3-aminopropyltriethoxysilane (AMEO), 3-aminopropyltrimethoxysilane (AMMO) and tri-amino-functional propyltrimethoxysilanes (e.g. Dynasylan® TRIAMO from Evonik Industries AG). The reaction of cyclic five-membered carbonate groups with aminosilanes is described in WO 2012/095293.

In a further embodiment of the present invention, the functional group of curing agent (B) comprises blocked amino groups. In this case, the reaction of the free amino group with the cyclic carbonate group on the polymer carrying carbonate groups is not quantitative, but rather substoichiometric. The conversion rate, based on the cyclic carbonate groups on the polymer, is in this embodiment in particular 10-90, preferably 20-80 and more preferably 40-60%. This ensures that there are still sufficient free cyclic carbonate groups available for the crosslinking of the binder. In contrast to the free amine, the blocked amino group does not react with the cyclic carbonate ring, but is instead available for crosslinking following application of the adhesive. For this purpose, the blocked amino group must be deprotected. This can be initiated by an increase in temperature, by an external radiation source or by moisture. Examples thereof are aminoaldimines or aminoketimines. On reaction with water, the aldimine or ketimine groups form an aldehyde or ketone, respectively, and an amino group, which is able to crosslink with the unreacted cyclic carbonate groups. These curing agents are therefore latent amine curing agents, which react with the carbonate-carrying polymer (A) only in the presence of moisture.

In a particularly preferred embodiment the further functional group is an amino group, meaning that, in particular, compounds having two amino groups are used as curing agents (B).

More particularly the curing agent (B) comprises aliphatic or cycloaliphatic amines, preferably aliphatic amines, with corresponding diamines being especially preferred. Aromatic amines are less desirable, on account of their toxicological properties and their low reactivity. Otherwise, there are no further restrictions on the structure of the amines. Both linear and branched structures are suitable. There are likewise no restrictions on the molecular weight. The curing agent (B) is therefore selected preferably from the group of the alkylenediamines or cycloalkylenediamines.

Alkylenediamines are compounds of the general formula R¹R²N—Z—NR³R⁴, in which R¹, R², R³, R⁴ independently of one another may be H, alkyl radicals or cycloalkyl radicals. Z is a linear or branched, saturated or unsaturated alkylene chain having at least 2 C atoms. Preferred examples are diaminoethane, diaminopropane, 1,2-diamino-2-methylpropane, 1,3-diamino-2,2-dimethylpropane, diaminobutane, diaminopentane, 1,5-diamino-2-methylpentane, neopentyldiamine, diaminohexane, 1,6-diamino-2,2,4-trimethylhexane, 1,6-diamino-2,4,4-trimethylhexane, diaminoheptane, diaminooctane, diaminononane, diaminodecane, diaminoundecane, diaminododecane, dimer amine (available commercially, for example, under trade name Versamin 551 from Cognis), triacetonediamine, dioxadecanediamine N,N-bis(3-aminopropyl)-dodecylamine (available commercially, for example, under the trade name Lonzabac 12.30 from Lonza), or mixtures thereof.

Cycloalkylenediamines are compounds of the general formula R⁵R⁶N—Y—NR⁷R⁸, in which R⁵, R⁶, R⁷, R⁸ independently of one another may be H, alkyl radicals or cycloalkyl radicals. Y is a saturated or unsaturated cycloalkyl radical having at least 3 C atoms, preferably at least 4 C atoms. Preferred are diaminocyclopentanes, diaminocyclohexanes, diaminocycloheptanes, examples being 1,4-cyclohexanediamine, 4,4′-methylenebiscyclohexylamine, 4,4′-isopropylenebiscyclohexylamine, isophoronediamine, m-xylylenediamine, N-aminoethylpiperazine or mixtures thereof.

The diamines may also contain both alkyl radicals and cycloalkyl radicals together. Preferred examples are aminoethylpiperazine, 1,8-diamino-p-menthane, isophoronediamine, 1,2-(bisaminomethyl)cyclohexane, 1,3-(bisaminomethyl)cyclohexane, 1,4-(bisaminomethyl)cyclohexane, bis(4-aminocyclohexyl)methane.

Further examples of diamines that can be used as curing agents (B) in accordance with the invention are bis(6-aminohexyl)amine, α,α-diaminoxylenes, etc.

Particularly preferred for use are bifunctional aliphatic and cycloaliphatic amines or polyetheramines, more particularly diaminoethane, diaminobutane, diaminohexane, neopentyldiamine, 1,4-cyclohexanediamine or isophoronediamine. However, amines having more than two functionalities are also possible. These include, for example, diethylenetriamine, triethylenetetramine, tetraethylenepentamine, etc. Highly branched structures as well, such as dendrimers, for example, can be used. Likewise preferred are amine-functionalized polymers, such as polyethyleneimines or amine-functionalized polyalkylene glycols, for example. Mixtures of different aliphatic or cycloaliphatic amines may also be used.

Also possible are mixtures of two or more different amines in any proportion. Very particular preference is given to using diaminoethane, diaminobutane, diaminohexane, isophoronediamine and polyetheramines as curing agents (B).

The ratio of the functional groups in the polymers (A) carrying cyclic carbonate groups and in the curing agents (B) is selected so as to give a stoichiometric ratio of cyclic carbonate groups to amines. The weight fraction of the polymer (A) carrying cyclic carbonate groups in the isocyanate-free polyurethane adhesive is 1-99%, preferably 20-95%, and more preferably 50-90%.

A catalyst may optionally be added to the polyurethane adhesives of the invention. Such catalysts are preferably metal salts which act as a Lewis acid or Lewis base. Examples of suitable catalysts are calcium salts or magnesium salts. Nitrogen compounds as well, for example tertiary amines such as triazabicyclo[4.4.0]dec-5-ene, exhibit catalytic activity. Mixtures can also be employed. The catalysts may be present in homogeneous form or as encapsulations in the mixture.

Preference is given to using halides, triflates, acetates, acetylacetonates, citrates and lactates of main group metals. Particularly preferred is calcium bromide, calcium triflate and zinc chloride.

The isocyanate-free polyurethane adhesives of the invention may additionally comprise the additives which are customary in the field of the art and which are well known to the skilled person. The additives may be, for example, rheology modifiers, such as Aerosil®, unfunctionalized polymers, e.g. thermoplastic polyurethanes (TPU) and/or polyacrylates and/or ethylene-vinyl acetate copolymers (EVA); pigment and/or fillers, e.g. talc, silicon dioxide, titanium dioxide, barium sulphate, calcium carbonate, carbon black or coloured pigments, external flame retardants; tackifiers, such as rosins, hydrocarbon resins, phenolic resins, hydrolysis stabilizers, and also ageing inhibitors and auxiliaries.

Likewise provided for the present invention is the use of the isocyanate-free polyurethane adhesives of the invention as one-part or two-part adhesives, sealants or coating materials.

Where the polyurethane adhesive of the invention is used in accordance with the invention as a one-part hotmelt adhesive, this means that the polymeric binder (A) and curing agent (B) and also the further, optional constituents can be combined beforehand and before adhesive application can be stored together at room temperature for a certain time, during which there should not be any crosslinking of the adhesive.

The production of the isocyanate-free polyurethane adhesives of the invention is accomplished most simply by mixing of the individual components in the melt. Mixing may take place, for example, in a stirring vessel, in a kneading apparatus or in an extruder. It must be ensured that all of the individual components at the mixing temperature are present either in liquid phase or can be dispersed in the melt. The melting temperature is also dependent on the viscosity of the constituents. It ought to below the curing temperature, customarily within a range of 50 to 200° C., preferably at 50-150° C. It is selected such that there is no crosslinking.

The isocyanate-free polyurethane adhesives of the invention are generally stable on storage at room temperature. This means that there is no significant crosslinking reaction. The degree of crosslinking may be monitored, for example, by way of the melt viscosity. The viscosity after storage must be low enough for the substrate to be wetted at the set application temperature. Moreover, sufficient functional groups must still be available to ensure curing within the bondline.

The isocyanate-free polyurethane adhesives of the invention are applied at a temperature above the softening point of all of the individual components, in the form of a melt, preferably at 50 to 200° C. Curing takes place by the ring-opening of the cyclic carbonate groups with the amino groups of the curing agent (B), preferably primary amino groups. Depending on the application temperature and on the structure of the amine, the reaction is optionally accelerated by means of the catalyst. The substrate may optionally be preheated, or the joined component may be held, with fixing, at a temperature above room temperature, in order to ensure a sufficient reaction time. Inductive curing is a further possibility.

After it has cooled, the adhesive bond obtained is stable. It exhibits high elongation, high ultimate strength and the effective adhesion typical of polyurethane adhesives.

The adhesion can be adjusted for a broad spectrum of substrates by way of the polymers used that carry cyclic carbonate groups. Possible substrates identified by way of example are metals, such as steel or aluminium, plastics, such as polyamide, polycarbonate, polyethylene terephthalate or ABS, especially fibre-reinforced plastics (FRPs) such as carbon fibre- or glass fibre-reinforced polyesters or epoxides (CRP and GRP) and sheet moulding compounds (SMC), and also wood, glass, glass-ceramic, concrete, mortar, brick, stone, paper, textiles and foams. In principle there are no restrictions on the use of the hotmelt adhesive of the invention. More particularly the adhesive bonds are bonds in the automotive and transport sector, in the construction industry, in the wood-processing industry, and in the graphical and textile industries.

Particular preference is given to primarily coating the hotmelt adhesive on one substrate. For this, the formulation is briefly melted and is applied to the substrate. This operation must be carried out with sufficient rapidity that the thermal load is small and there is no significant crosslinking reaction, and there are still sufficient functional groups available for the subsequent curing. After preliminary coating, the substrate is cooled preferably to room temperature and at such temperatures may be storage-stable. For the actual adhesive bonding, the pre-coated adhesive is reactivated by introduction of heat and is bonded to the second substrate. The advantage of this process is a physical and temporal separation between adhesive application and the said bonding. This makes the assembly operation much simpler. The pre-coated substrate is preferably a paper sheet or polymeric film, used for laminating components of large surface area, e.g. in furniture production or in the interior of vehicles, in profile wrapping and in initial edge gluing.

In one particular embodiment, the isocyanate-free polyurethane adhesive of the invention is delivered as a sheet of adhesive or is applied to a carrier sheet which is removed before the bond is produced.

In another embodiment, the isocyanate-free polyurethane adhesive of the invention is ground and for the production of the bond is applied in powder form.

In a further preferred embodiment, the isocyanate-free polyurethane adhesives of the invention are used in the form of two-part polyurethane adhesives. This means that the polymeric binder (A) carrying carbonate groups and the curing agent (B) are stored and melted separately from one another. Not until immediately prior to adhesive application are the two components mixed with one another in melt form. The resulting adhesive formulation is applied without further storage directly to one of the substrates where bonding is to take place, and is bonded to a second substrate within the open time by brief applied pressure.

The mixing ratio is selected such as to give a stoichiometric ratio between cyclic carbonate groups and amino groups. The mixing ratio and hence the carbonate/amine ratio is situated preferably between 1.0: 0.8 to 1.0: 3.0, very preferably between 1.0: 1.0 to and 1.0: 1.5 and very preferably at 1: 1.

The mixing can be effected by dynamic or static means. Preferably, the two parts are processed from heatable cartridges with the aid of a manual or pneumatic gun and a static mixer. The two parts can also be dispensed into larger containers such as drums or hobbocks and melted prior to processing in suitable melting units, for example with heatable drum melting units, and metered and mixed with pumping systems.

Even without further exposition it is believed that a person skilled in the art will be able to make the widest use of the above description. The preferred embodiments and examples are therefore to be understood merely as a descriptive disclosure which is not in any way intended to be limiting.

The present invention will now be more particularly described with reference to examples. Alternative embodiments of the present invention are obtainable analogously.

### EXAMPLES

### Polyester Example P1

The inventive isocyanate-free polyester P 1 carrying carbonate groups is prepared in accordance with EP 15153944.2-1301. In the first stage, a carboxyl-terminated polyester is prepared from 648 g of adipic acid and 515 g of 1,6-hexanediol in the presence of 0.5 g of monobutylstannic acid. The acid number (AN) is 11 mg KOH/g, the hydroxyl number 0.9 mg KOH/g. The second stage comprises reaction with 27.8 g of glycerol carbonate.

The bifunctional polyester P 1 has a molar weight of 10 460 g/mol, an equivalent weight of 5230 g/mol, an acid number of 0.8 mg KOH/g, measured according to DIN EN ISO 22154, and a hydroxyl number of 6.2 mg KOH/g, measured according to DIN 53240-2. The softening point, measured as DSC melting point according to DIN 53765, is 55° C. The viscosity, measured according to DIN EN ISO 3219, is 27.8 Pas at 80° C. and 5.8 Pas at 130° C.

The molar weight is calculated according to the following equation.

$$Molar weight P in \frac{g}{mol} = \frac{56106 \frac{mgKOH}{g}}{AN Stage 1} + 128 \frac{g}{mol} ⋆ Functionality$$

### Polyester Example P2

In the first stage, in analogy to Example 1, a carboxyl-terminated polyester is prepared from 664 g of adipic acid and 508 g of 1,6-hexanediol. The acid number is 29 mg KOH/g, the hydroxyl number 0.9 mg KOH/g. The second stage comprises reaction with 66.5 g of glycerol carbonate in the presence of 0.5 g of monobutylstannic acid.

The bifunctional polyester P 2 has a molar weight of 4120 g/mol, an equivalent carbonate weight of 2060 g/mol, an acid number of 1.6 mg KOH/g, measured according to DIN EN ISO 22154, and a hydroxyl number of 5.9 mg KOH/g, measured according to DIN 53240-2. The softening point, measured as DSC melting point according to DIN 53765, is 52° C. The viscosity, measured according to DIN EN ISO 3219, is 4 Pas at 80° C.

### Polyester Example P3

In the first stage, in analogy to Example 1, a carboxyl-terminated polyester is prepared from 678 g of adipic acid, 467 g of 1,6-hexanediol and 31.6 g of trimethylolpropane. The acid number is 44 mg KOH/g, the hydroxyl number 2.0 mg KOH/g. The second stage comprises reaction with 111 g of glycerol carbonate in the presence of 0.6 g of monobutylstannic acid.

The polyester P 3 has a molar weight of 4070 g/mol, an equivalent carbonate weight of 1400 g/mol, an acid number of 0.4 mg KOH/g, measured according to DIN EN ISO 22154, and a hydroxyl number of 16 mg KOH/g, measured according to DIN 53240-2. The functionality is 2.9.

The viscosity, measured according to DIN EN ISO 3219, is 12 Pas at 80° C.

### Adhesive Example A1

Production of an Adhesive A1

In a 500 ml flat-flange flask, 200 g of polyester P1 are melted. At a temperature of 80° C., 2.2 g of the curing agent, diaminohexane, are added, corresponding to a carbonate/amine ratio of 1:1, and the mixture is rapidly homogenized. Stirring of the reactants is continued at 80° C. for rapid reaction. The conversion in the reaction is monitored via the evolution of the amine number, measured according to DIN 53176.

After 4 hours, the amine number has dropped to 1.4 mg KOH/g and the reaction is at an end. The adhesive is discharged.

Adhesive A1 has a viscosity, measured according to DIN EN ISO 3219; of 193 Pas at 80° C. and 22 Pas at 130° C. The bond strength to wood, measured as tensile shear strength according to DIN EN 1465, is 2 N/mm².

### Adhesive Example A2

Production of Adhesive A2

In a 500 ml flat-flange flask, 200 g of polyester P2 are melted. At a temperature of 130° C., 5.8 g of the curing agent, diaminohexane, are added, corresponding to a carbonate/amine ratio of 1:1, and the mixture is rapidly homogenized. Stirring of the reactants is continued at 130° C. for rapid reaction. The conversion in the reaction is monitored via the evolution of the amine number, measured according to DIN 53176.

After 2 hours, the amine number has dropped to 0.3 mg KOH/g and the reaction is at an end. The adhesive is discharged.

Adhesive A2 has a viscosity, measured according to DIN EN ISO 3219; of 10.9 Pas at 130° C.

### Adhesive Example A3

In a 500 ml flat-flange flask, 120 g of polyester P2 and 30 g of polyester P3 are melted. At a temperature of 80° C., 4.7 g of the curing agent, diaminohexane, are added, corresponding to a carbonate/amine ratio of 1:1. The mixture is homogenized at 80° C. for ten minutes and then discharged.

The bond strength to wood, measured according to DIN EN 1465, is 0.4 N/mm². After 1 hour of curing at 140° C., the bond strength rises to 4.2 N/mm².

### Adhesive Example A4

In a 250 ml glass bottle, 140 g of polyester P3 are melted. At a temperature of 85° C., 3 g of the curing agent, diaminoethane, are added, corresponding to a carbonate/amine ratio of 1:1. The mixture is homogenized with a dissolver at 2000 revolutions per minute for one minute and then characterized.

For the determination of the softening point (ring and ball) according to DIN ISO 4624, the melted adhesive is poured into two rings and cooled. After storage at room temperature for 10 minutes, a softening point of 59° C. is found. After storage for an hour, the adhesive undergoes crosslinking and no longer fully melts.

Directly after preparation of the adhesive, a film 0.5 mm thick is applied to silicon paper using a 4-way bar applicator. After the melt has cooled, test dumbbells are punched out and stored at 20° C. After an hour, the tensile strength according to DIN 53504 is 3.6 MPa. After 24 hours, the tensile strength has risen to 5.5 MPa.

### Adhesive Example A5

A mixture consisting of 5 g of polyester P1 and 0.3 g diaminohexane (HMDA) is melted with stirring and is stirred at 120° C. This produces a clear melt of relatively high viscosity. After a reaction time of just 15 minutes, a marked rise in the viscosity is found, which indicates the onset of the reaction between the carbonate-terminated polyester and the diamine. After a reaction time of one hour and two hours at 120° C., samples of approximately 1 g are taken and are dissolved in chloroform. In order to remove any unreacted HMDA, the sample was admixed with about 1 g of finely mortared potassium hydrogen sulphate and stirred for 15 minutes in the form of a suspension. Following filtration, chloroform was removed on a rotary evaporator and the solid product was investigated by NMR analysis (CDCl₃ and DMSO-d₆).

The ¹H-NMR spectrum showed complete conversion of the carbonate end groups. Any further change in the ¹H-NMR spectrum after a reaction time of two hours was not visible. For complete characterization of the reaction, and to verify the formation of the hydroxyurethane, further analyses were carried out by ¹³C-NMR spectroscopy, IR-spectroscopy, and an elemental analysis. All of the methods confirm the formation of the corresponding polyurethane. Furthermore, the increase in molecular weight is apparent through gel permeation chromatography (GPC). No further increase could be found in the molecular weight of the samples after one hour and two hours.

1. A isocyanate-free polyurethane composition comprising polymers (A) carrying cyclic carbonate groups, which do not comprise or are not based on isocyanates, obtained by reaction of polymers which carry carboxyl groups, selected from the group encompassing polyesters based on diols or polyols and on dicarboxylic or polycarboxylic acids and/or derivatives thereof, or poly(meth)acrylates, with five-membered cyclic carbonates that are functionalized with hydroxyl groups, and a curing agent (B) having at least one amino group and at least one further functional group, wherein the further functional group is not an isocyanate group.

2. The isocyanate-free polyurethane composition according to claim 1, wherein the polymers carrying carboxyl groups are polyesters based on diols or polyols and on dicarboxylic or polycarboxylic acids and/or derivatives thereof.

3. The isocyanate-free polyurethane composition according to claim 1, wherein the amino groups of the curing agent (B) are primary amino groups.

4. The isocyanate-free polyurethane composition according to claim 1, wherein the further functional group comprises amino, silyl, vinyl or thiol groups.

5. The isocyanate-free polyurethane composition according to claim 1, wherein the curing agent (B) comprises aliphatic or cycloaliphatic amines.

6. The isocyanate-free polyurethane composition according to claim 1, wherein the weight fraction of the polymer (A) carrying cyclic carbonate groups in the isocyanate-free polyurethane composition is 1-99%.

7. The isocyanate-free polyurethane composition according to claim 1, wherein a catalyst is added to the polyurethane compositions.

8. The isocyanate-free polyurethane composition according to claim 1, wherein they further comprise additives.

9. The isocyanate-free polyurethane composition according to claim 8, wherein the additives comprise rheology modifiers, unfunctionalized polymers, pigments and/or fillers, external flame retardants; tackifiers, and also ageing inhibitors and auxiliaries.

10. A one-part or two-part adhesive comprising the isocyanate-free polyurethane compositions according to claim 1.

11. A sealant comprising the isocyanate-free polyurethane compositions according to claim 1.

12. A coating material comprising the isocyanate-free polyurethane compositions according to claim 1.

13. The isocyanate-free polyurethane composition according to claim 2, wherein the amino groups of the curing agent (B) are primary amino groups.

14. The isocyanate-free polyurethane composition according to claim 2, wherein the further functional group comprises amino, silyl, vinyl or thiol groups.

15. The isocyanate-free polyurethane composition according to claim 2, wherein the curing agent (B) comprises aliphatic or cycloaliphatic amines.

16. The isocyanate-free polyurethane composition according to claim 2, wherein the weight fraction of the polymer (A) carrying cyclic carbonate groups in the isocyanate-free polyurethane composition is 1-99%.

17. The isocyanate-free polyurethane composition according to claim 1, wherein a catalyst is added to the polyurethane compositions.

18. The isocyanate-free polyurethane composition according to claim 1, wherein they further comprise additives.

19. The isocyanate-free polyurethane composition according to claim 8, wherein the additives comprise rheology modifiers, unfunctionalized polymers, pigments and/or fillers, external flame retardants; tackifiers, ageing inhibitors and auxiliaries.

20. The isocyanate-free polyurethane composition according to claim 3, wherein the curing agent (B) comprises aliphatic or cycloaliphatic amines.
